(19) United States
(12) Patent Application Publication
(10) Pub. No.: US 2006/0156058 A1
(43) Pub. Date: Jul. 13, 2006

(54) Data management apparatus, data management method and data management program

(75) Inventors: Masaru Koga, Mishima-shi (JP); Toshiharu Takahashi, Tokyo (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/231,220

(22) Filed: Sep. 19, 2005

(30) Foreign Application Priority Data
Jan. 11, 2005 (JP) 2005-3545

(51) Int. Cl. G06F 11/00

(52) U.S. Cl. 714/5

(57) ABSTRACT

There is disclosed a technique that can reliably erase data to achieve an enhanced level of security, while suppressing the problem of low operability and that of poor response of some other process due to an increased load. A data management apparatus for managing the data of a file system comprises a path information altering section for altering the contents of the path information indicating the location of the file to be erased according to a file erasing request for erasing the file so as to indicate a predetermined location, a task monitoring section for monitoring the state of the task being executed by the CPU adapted to execute processes relating to the file system and an erasing task executing section for executing an erasing task of erasing the real data of the file for which the contents of the path information are set to indicate the predetermined location according to the state being monitored by the task monitoring section at a time when no predetermined task other than the erasing task is being executed.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### RELATED APPLICATION INFORMATION

This patent is related to, which is incorporated herein by reference.

### BACKGROUND OF THE INVENTION

1. Field of the Invention

The present invention relates to data management in a file system. More particularly, the present invention relates to erasure of real data of a file.

2. Description of the Related Art

FAT file systems are known as typical systems for managing files on a hard disk. A FAT file system is composed of data of three types including a FAT (file allocation table), a directory entry and files which are real data. When deleting a file from an ordinary FAT file system, the FAT and the directory entry that provide information on the locations of real data on the hard disk are deleted but real data are left on the hard disk so that there is a demand for techniques of completely erasing the real data left on the hard disk from a security point of view.

As a matter of fact, such techniques of erasing real data formed on a hard disk by overwriting the data left in the real data region of a hard disk with specific data (see, inter alia, Patent Document 1: Jpn. Pat. Appln. Laid-Open Publication No. 2004-7059 (pp. 4-9, FIG. 1, Patent Document 2: Jpn. Pat. Appln. Laid-Open Publication No. 2004-153516 (pp. 4-9, FIG. 15).

However, the process of overwriting the data in the real data region with specific data involves a heavy load and if such an overwriting process is executed concurrently with some other process, there can arise a problem in terms of operability and response of the some other process.

### SUMMARY OF THE INVENTION

In view of the above-identified problem, it is therefore an object of the present invention to provide a technique that can reliably erase data to achieve an enhanced level of security, while suppressing the problem of low operability and that of poor response of some other process due to an increased load.

In an aspect of the present invention, the above object is achieved by providing a data management apparatus for managing the data of a file system, the apparatus comprising a path information altering section for altering the contents of path information indicating the location of a file to be erased according to a file erasing request for erasing the file so as to indicate a predetermined location, a task monitoring section for monitoring the state of the task being executed by a CPU adapted to execute processes relating to the file system and an erasing task executing section for executing an erasing task of erasing real data of the file for which the contents of the path information are set to indicate the predetermined location according to the state being monitored by the task monitoring section at a time when no predetermined task other than the erasing task is being executed.

In another aspect of the present invention, there is also provided a data management method for managing data of a file system, the method comprising a step that alters the contents of path information indicating the location of a file to be erased according to a file erasing request for erasing the file so as to indicate a predetermined location, a task monitoring step that monitors the state of the task being executed by a CPU adapted to execute processes relating to the file system and an erasing task executing step that executes an erasing task of erasing real data of a file for which the contents of the path information are set to indicate the predetermined location according to the state being monitored in the task monitoring step at a time when no predetermined task other than the erasing task is being executed.

In still another aspect of the present invention, there is provided a data management program for causing a computer to execute a process for managing a file system, the program comprising a step that alters the contents of path information indicating the location of a file to be erased according to a file erasing request for erasing the file so as to indicate a predetermined location, a task monitoring step that monitors the state of the task being executed by a CPU adapted to execute processes relating to the file system and an erasing task executing step that executes an erasing task of erasing real data of a file for which the contents of the path information are set to indicate the predetermined location according to the state being monitored in the task monitoring step at a time when no predetermined task other than the erasing task is being executed.

Thus, according to the present invention, it is possible to provide a technique that can reliably erase data to achieve an enhanced level of security, while suppressing the problem of low operability and that of poor response of some other process due to an increased load.

### DESCRIPTION OF THE DRAWINGS

FIG. 1 is a schematic cross sectional view of an embodiment of image processing apparatus provided with an embodiment of data management apparatus according to the invention.

FIG. 2 is a schematic functional block diagram illustrating the embodiment of data management apparatus of FIG. 1 and that of image processing apparatus provided with the embodiment of data management apparatus.

FIG. 3 is a flowchart illustrating the flow of a process to be executed by an embodiment of data management method according to the invention.

### DETAILED DESCRIPTION OF THE INVENTION

Throughout this description, the embodiments and examples shown should be considered as exemplars, rather than limitations on the apparatus and methods of the present invention.

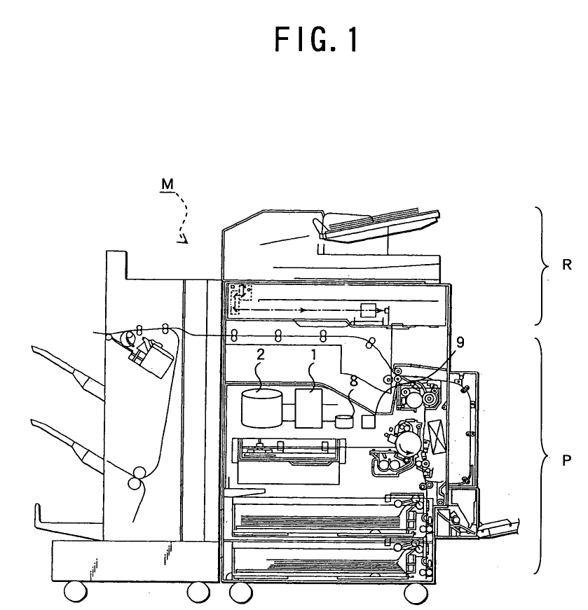

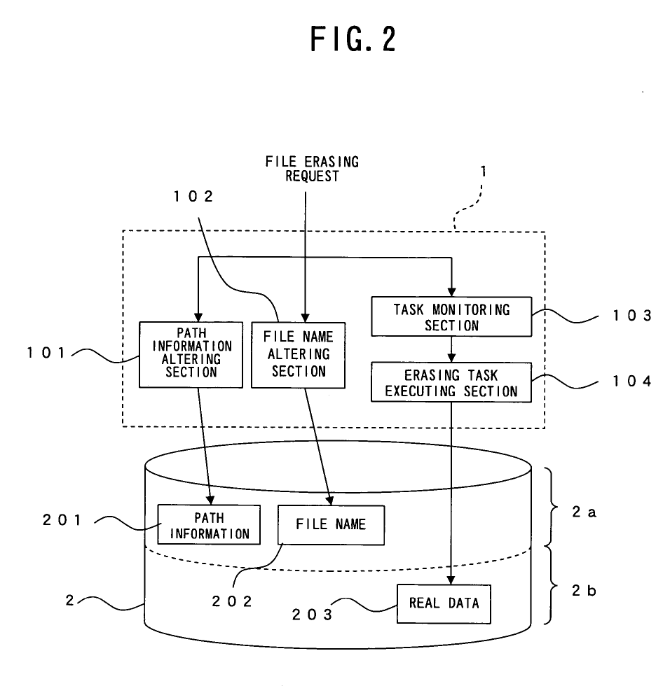

Now, preferred embodiments of the invention will be described in greater detail by referring to the accompanying drawings. FIG. 1 is a schematic cross sectional view of an embodiment of image processing apparatus provided with an embodiment of data management apparatus according to the invention. FIG. 2 is a schematic functional block diagram illustrating the embodiment of data management apparatus of FIG. 1 and that of image processing apparatus provided with the embodiment of data management apparatus.

The image processing apparatus M of this embodiment comprises an image reading section R for reading an original to obtain an image thereof, an image forming section P for forming the image of the original on a sheet, a memory 8, a CPU 9, a memory region 2 and a data management apparatus 1. The image processing apparatus M can execute a copying process of forming the image of the original read by the image reading section R on a sheet by the image forming section P.

The memory region 2 is typically formed by a hard disk and includes a management region 2a that stores management information such as path information 201, which is information relating to the locations, the file names 202 and so on of the files by a file system and a real data region 2b that stores a real data 203 of the files. The file system for managing the groups of data stored in the memory region 2 may typically be a FAT file system and the CPU 9 is responsible for executing processes relating to the file system. More specifically, file data that can be stored in the memory region 2 include the video files (so called intermediate data) generated by image reading processes of the image reading section R and image forming processes and copying processes of the image forming section P.

The CPU 9 takes the role of executing various processes of the image processing apparatus M. The memory 8 is formed by a ROM, a RAM and so on and stores various pieces of information to be used by the image processing apparatus M and programs to be executed by the CPU 9.

The data management apparatus 1 of this embodiment takes the role of managing the file data managed by the file system and stored in the memory region 2. The data management apparatus 1 comprises a path information altering section 101, a file name altering section 102, a task monitoring section 103 and an erasing task executing section 104.

The path information altering section 101 takes the role of altering the contents of the path information of the file to be erased according to a file erasing request to those that indicates a predetermined location.

The file name altering section 102 takes the role of altering the contents of the file name of the file to be erased according to the file erasing request to predetermined contents.

The task monitoring section 103 takes the role of monitoring the state of the task being executed by the CPU 9 that is responsible for executing processes relating to the file system.

The erasing task executing section 104 takes the role of executing the erasing task of overwriting and erasing the real data of the file for which the contents of the path information are set to indicate the predetermined location according to the state being monitored by the task monitoring section at a time when no predetermined task other than the erasing task is being executed.

While a memory region 2 and a data management apparatus 1 are arranged in an image processing apparatus in this embodiment, the present invention is by no means limited thereto and it may alternatively be so arranged that at least either a memory region 2 or a data management apparatus 1 is placed outside the image processing apparatus M and connected to the latter in a communicable way.

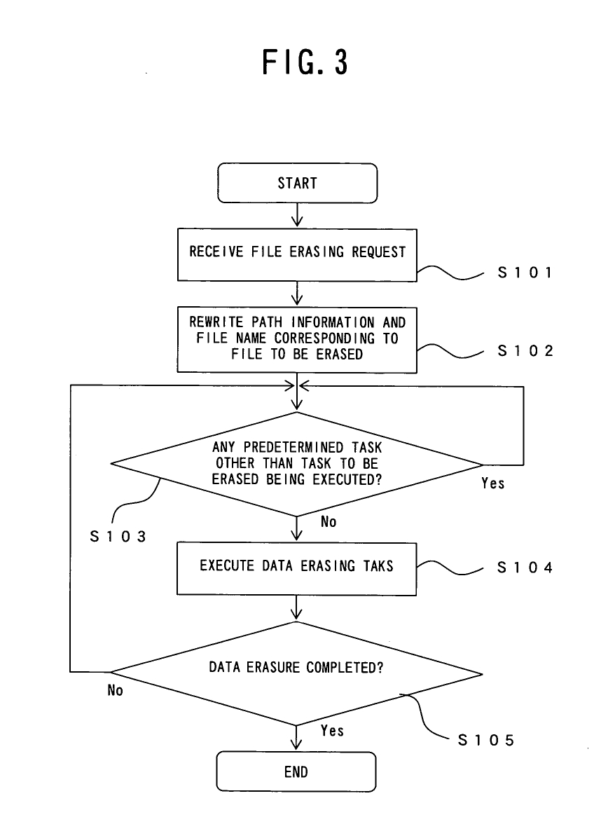

Now, an embodiment of data management method according to the invention will be described below. FIG. 3 is a flowchart illustrating the flow of a process to be executed by this embodiment of data management method according to the invention.

Here, the flow of a process of erasing video file “/AAA/DIR0/data0.img”, which are the intermediate data generated in the course of a copying process of the image processing apparatus M will be described. Note that “AAA” denotes a partition generated in the memory region 2, “DIR0” denotes a directory and “data0.img” denotes a file.

Firstly, the path information altering section 101 alters the path information 201 “/AAA/DIR0/ . . . ” that is information relating to the location of the file to be erased according to an erasing request to make it have contents of “/AAA/DUST/ . . . ” indicating a predetermined location (dust bin folder) according to a file erasing request (S101) (path information altering step) (S102).

As a result of the path information altering step (which corresponds to a move of a file), the absolute path of the video file becomes “/AAA/DUST/data0.img” and the host task recognizes that the file is erased so that it can quickly goes to the next process as a result of the alteration of the location (directory) of the video file.

Note that the path information that indicates the predetermined location is so defined that it is found in the partition same as the partition where the path information to be erased (“AAA” in this instance”) is located. Thus, the processing load of the CPU 9 is alleviated as the path information can be altered simply by moving the directory within the same partition.

Then, the file name altering section 102 alters the file name 202 “data0.img” that is the name of the file requested to be erased to a predetermined file name (e.g., “DUST_data0.img”) according to the file erasing request (S102). As a result of the alteration of the file name, the absolute path of the video file is turned to be “/AAA/DUST/DUST_data0.img”. Thus, the host task recognizes that the video file is erased and hence it can quickly move to the next process as the directory entry of the file name of the video file is rewritten in this way.

Note that the above described path information altering step may be executed before the file name altering or vice versa. What is important is that the two steps are completed as a result.

Then, the task monitoring section 103 monitors the state of the task being executed by the CPU 9 at a predetermined timing (e.g., periodically) to execute a process that relates to the file system, using the reception of the file erasing request as cue (task monitoring step).

The erasing task executing section 104 executes the erasing task of erasing the real data 203 of the file “DUST_data0.image” located in the predetermined position “/AAA/DUST/ . . . ” according to the state of being monitored in the task monitoring step at a time when no predetermined task other than the erasing task is being executed (erasing task executing step) (104).

A predetermined task other than the erasing task refers to a task that is defined in advance that the CPU 9 is subjected to an excessive processing load if it is executed concurrently with the erasing task. For example, such a task may be a rendering process of the user interface, an image reading process, a copying process of a image forming process. On the other hand, a task that the CPU 9 can concurrently execute with the erasing task may, for example, be a FAX receiving process or an E-mail receiving process at the image processing apparatus M.

More specifically, the erasing task executing section 104 executes a process of overwriting the real data of the file, in which the path information indicates a predetermined location, with predetermined data. Thereafter, it deletes the FAT and the directory entry stored in the management region 2a and completely erases the data of the file stored in the memory region 2. The real data of the file are erased by overwriting them with a fixed value, with the complement of a fixed value or with a random number. After the overwriting process, it is desirable that the data in the region of the erased real data are read out to verify the overwritten data.

Additionally, it is desirable that the erasing task executing section 104 is so arranged that it suspends the execution of the erasing task when a predetermined task is executed while it is executing the erasing task.

Then, after erasing the real data by the erasing task, the erasing task executing section 104 checks if there is any other file that is requested to be erased or not by checking if there is a file set at a predetermined location or not.

If the power supply to the image processing apparatus M is turned OFF during the process and the data are not completely erased, the erasing task executing section 104 executes the interrupted erasing task once again when the power supply to the image processing apparatus M is turned ON for the next time.

With the above described arrangement, the CPU 9 can move to the operation of processing a necessary task when it is required to be processed (e.g., when there is a request for a copying operation). Thus, it is possible to maintain the level of responsiveness of the process above a predetermined level in the entire apparatus.

The steps (S101 through S105) of the data management method of this embodiment are realized by having the CPU 9 execute the data management program stored in the memory 8.

While the embodiment is described above on an assumption that the feature for realizing the present invention is prerecorded in the inside of the apparatus. However, the present invention is by no means limited thereto and a similar feature may be downloaded to the apparatus from a network or a recording medium that stores a similar feature may be installed in the apparatus. For the purpose of the present invention, any recording medium such as a CD-ROM may be used for storing such a feature so long as the apparatus can read the stored feature. If the feature is acquired by installing or downloading it in advance, it may be so arranged that the feature is realized when it cooperates with the OS (operating system) in the inside of the apparatus.

Thus, with the above-described embodiment, it is possible to have the host task recognize that the file to be erased is apparently erased by altering the path information and the directory entry of the file to be erased so that the processing speed of the host task can be prevented from lowering. The independent erasing task erases the real data to be erased when no predetermined task other than the erasing task is being executed. Therefore, the real data would not leak due to the format of installation.

Additionally, the file to be erased is moved (shunted) to a predetermined location and the file name of the file is altered to remarkably reduce the possibility of retrieving the file to remarkably enhance the level of security.

While the present invention is described by way of specific embodiments, it may be clear to those skilled in the art that any of the described embodiments can be modified and/or altered without departing from the spirit and scope of the present invention.

It is claimed:

1. A data management apparatus for managing data of a file system, the apparatus comprising:
a path information altering section for altering the contents of path information indicating the location of a file to be erased according to a file erasing request for erasing the file so as to indicate a predetermined location;
a task monitoring section for monitoring the state of the task being executed by a CPU adapted to execute processes relating to the file system; and
an erasing task executing section for executing an erasing task of erasing real data of the file for which the contents of the path information are set to indicate the predetermined location according to the state being monitored by the task monitoring section at a time when no predetermined task other than the erasing task is being executed.

2. The apparatus according to claim 1, further comprising:
a file name altering section for altering the contents of the file name of the file requested to be erased according to the file erasing request to predetermined ones.

3. The apparatus according to claim 1, wherein
the erasing task executing section suspends the execution of the erasing task when a predetermined task is executed while the erasing task is being executed.

4. The apparatus according to claim 1, wherein
the erasing task is a task of overwriting the real data of the file, for which the contents of the path information is set to indicate the predetermined location, with predetermined data.

5. The apparatus according to claim 1, wherein
the path information, whose contents indicate the predetermined location, is so set as to be found in the same and identical partition with the path information of the file that is requested to be erased.

6. The apparatus according to claim 1, further comprising, wherein
an image reading section for reading an original to obtain an image thereof;
the file that is requested to be erased is a video file generated by an original reading/image obtaining process of the image reading section, and the apparatus composes an image processing apparatus.

7. A data management method for managing data of a file system, the method comprising:
a step that alters the contents of path information indicating the location of a file to be erased according to a file erasing request for erasing the file so as to indicate a predetermined location;
a task monitoring step that monitors the state of the task being executed by a CPU adapted to execute processes relating to the file system; and
an erasing task executing step that executes an erasing task of erasing real data of a file for which the contents of the path information are set to indicate the predetermined location according to the state being monitored in the task monitoring step at a time when no predetermined task other than the erasing task is being executed.

8. The method according to claim 7, further comprising:
a file name altering step that alters the contents of the file name of the file requested to be erased according to the file erasing request to predetermined ones.

9. The method according to claim 7, wherein
the erasing task executing step suspends the execution of the erasing task when a predetermined task is executed while the erasing task is being executed.

10. The method according to claim 7, wherein
the erasing task is a task of overwriting the real data of the file, for which the contents of the path information is set to indicate the predetermined location, with predetermined data.

11. The method according to claims 7, wherein
the path information, whose contents indicate the predetermined location, is so set as to be found in the same and identical partition with the path information of the file that is requested to be erased.

12. A data management program for causing a computer to execute a process for managing a file system, the program comprising:
a step that alters the contents of path information indicating the location of a file to be erased according to a file erasing request for erasing the file so as to indicate a predetermined location;
a task monitoring step that monitors the state of the task being executed by a CPU adapted to execute processes relating to the file system; and
an erasing task executing step that executes an erasing task of erasing real data of a file for which the contents of the path information are set to indicate the predetermined location according to the state being monitored in the task monitoring step at a time when no predetermined task other than the erasing task is being executed.

13. The program according to claim 12, further comprising:
a file name altering step that alters the contents of the file name of the file requested to be erased according to the file erasing request to predetermined ones.

14. The program according to claim 12, wherein
the erasing task executing step suspends the execution of the erasing task when a predetermined task is executed while the erasing task is being executed.

15. The program according to claim 12, wherein
the erasing task is a task of overwriting the real data of the file, for which the contents of the path information is set to indicate the predetermined location, with predetermined data.

16. The program according to claim 12, wherein
the path information, whose contents indicate the predetermined location, is so set as to be found in the same and identical partition with the path information of the file that is requested to be erased.
